(19) United States
(12) Patent Application Publication
(10) Pub. No.: US 2020/0088635 A1
(43) Pub. Date: Mar. 19, 2020

(54) Crystal purity detecting apparatus

(71) Applicant: Jianhua Yao, Foshan City (CN)

(72) Inventor: Jianhua Yao, Foshan City (CN)

(21) Appl. No.: 16/687,631

(22) Filed: Nov. 18, 2019

(30) Foreign Application Priority Data
Apr. 18, 2019 (CN) 2019103152189

(51) Int. Cl. G01N 21/59; G01N 21/95; G01N 21/01

(52) U.S. Cl. CPC G01N 21/59; G01N 2021/8477; G01N 21/01; G01N 21/95

(57) ABSTRACT

The invention discloses a crystal purity detecting apparatus, including a machine body, wherein the detecting body is provided with a detecting chamber, and a detecting device is arranged in the detecting chamber, and a symmetric power chamber is arranged in the inner wall of the left and right sides of the detecting chamber. The detecting chamber is provided with a lifting device, the power chamber is provided with a transmission device, and the power chamber is provided with a power device; the invention has the advantages of simple structure, convenient operation and convenient maintenance, and the device can perform various positions on the crystal the detection, the accuracy of the device judgment is high, and the labor intensity of the professional is lowered, so the device has high use and promotion value.

### CROSS-REFERENCES TO RELATED APPLICATIONS

The present application claims priority from Chinese application No. 2019103152189 filed on Apr. 18, 2019 which is hereby incorporated by reference in its entirety.

### TECHNICAL FIELD

The invention relates to the technical field of crystal detecting, in particular to a crystal purity detecting apparatus.

### BACKGROUND OF THE INVENTION

Crystal is affected by the environment, its purity is different, and the purity of crystal directly affects the value of crystal. At present, the detection of crystal purity is mostly detected by professionals. This method has long detection time, high labor intensity, and error rate. Higher, therefore, the present invention aims to design a detection device that automatically detects the purity of crystal.

### CONTENT OF THE INVENTION

It is an object of the present invention to provide a crystal purity detecting apparatus capable of overcoming the above-described drawbacks of the prior art.

According to the present invention, a crystal purity detecting apparatus includes a body, a detecting chamber is disposed in the body, and a detecting device is disposed in the detecting chamber, and a symmetric power chamber is disposed in the inner wall of the left and right sides of the detecting chamber. a lifting device is disposed in the detecting chamber, a transmission device is disposed in the power chamber, and a power device is disposed in the power chamber, the power device includes a motor disposed in a left wall of the power chamber, the power A power shaft connected to the motor is provided in the cavity; the power device can drive the detecting device to rotate by the transmission device, and the purity detecting operation is performed on the crystal to be detected.

Preferably, the detecting device includes a detecting body disposed symmetrically in the detecting chamber, and the detecting body on the left side is taken as an example for detailed description. The detecting body is provided with a sliding cavity, and the sliding cavity is inside the sliding cavity. A support shaft is disposed on the upper and lower sides, and a sprocket is disposed on the outer wall of the support shaft, and a chain is arranged between the sprocket on the upper and lower sides, and the slide is slidably provided with a sliding frame, and the sliding The slider is slidably disposed on the chain, the slider is rotatably disposed on the chain, the right end of the sliding frame is provided with an illuminator, and the left end of the sliding frame is provided at the left end for receiving a photoreceptor of the light beam emitted by the illuminator, the front end of the support shaft on the lower side is provided with a pulley, the sleeve is provided with a sleeve shaft, and the outer wall of the sleeve shaft is provided with a main pulley, the main belt a first belt is disposed between the wheel and the slave pulley, a core shaft is disposed in the detection chamber, the mandrel is spline-fitted with the sleeve shaft, and an upper pulley is disposed at a front end of the mandrel a rack is disposed symmetrically on the left and right sides of the chain, and a threaded sleeve is disposed in the sliding cavity, and the outer wall of the threaded sleeve Provided with running gear, the detection chamber is provided with a screw traveling, the travel of the screw threadedly engaged with the threaded sleeve, with the tip of the screw from walking bevel gear; detecting means for detecting the crystal purity.

Preferably, the lifting device includes a base that is slidably disposed in the detecting chamber, and the base is slidably provided with a left-right symmetric middle rod, and the middle rod and the base are elastically provided a spring, a middle rod is slidably disposed in the middle rod, and a second spring is elastically disposed between the upper rod and the middle rod, and a top cover is connected to the top end of the upper rod, and a bottom end of the detecting chamber is connected a conversion chamber is arranged symmetrically in the front and rear walls, and an extension chamber is arranged between the power chambers on both sides, and the detection chamber is provided with a front and rear symmetrical lifting screw, and the lifting screw is screwed with the base. a bottom bevel gear is disposed at a bottom end of the lifting screw, an extension shaft is disposed in the conversion cavity, a rear bevel gear is disposed at an end of the extension shaft away from the extension cavity, and the extension shaft is disposed adjacent to an end of the extension cavity Front bevel gear; the lifting device can facilitate the placement of the crystal to be tested.

Preferably, the transmission device comprises a main shaft symmetrically disposed in the power chamber, wherein the left side is taken as an example for detailed description, and the main shaft on the left side is spline-fitted with the power shaft, and the left end of the main shaft a main gear is disposed, a right bevel gear is disposed at a right end of the main shaft, a sliding slot is disposed in a right wall of the power chamber, and a permanent magnet is slidably disposed in the sliding slot, and the outer wall of the main shaft is rotatably disposed a rotating block fixed to the permanent magnet, an electromagnet is disposed in the right wall of the sliding slot, a third spring is elastically disposed between the permanent magnet and the electromagnet, and a recovery shaft is disposed in the power cavity The right end of the recovery shaft is provided with a one-way gear, the left end of the recovery shaft is provided with a main bevel gear, the power chamber is provided with a transmission shaft, and the outer wall of the transmission shaft is provided with a slave gear, and the transmission shaft is left and right a right bevel gear is disposed symmetrically, a lower shaft is disposed in the power chamber, a left bevel gear is disposed at a rear end of the lower shaft, and a lower pulley is disposed at a front end of the lower shaft, and the lower pulley and the upper pulley a second belt is provided between the pulleys; the transmission transmits power to each of the above Set inside.

The invention has the advantages that the structure is simple, the operation is convenient, and the maintenance is convenient. The device can detect various positions of the crystal, the accuracy of the device judgment is high, and the labor intensity of the professional is lowered, so the device has high Use and promotion value.

### BRIEF DESCRIPTION OF THE DRAWINGS

In order to more clearly illustrate the embodiments of the invention or the technical solutions in the prior art, the drawings used in the embodiments or the description of the prior art will be briefly described below.

FIG. 1 is a schematic view showing the overall structure of a crystal purity detecting apparatus of the present invention;

FIG. 2 is a schematic structural view of A in FIG. 1;

FIG. 3 is a schematic structural view along B-B direction of FIG. 1;

FIG. 4 is a schematic structural view along C-C direction of FIG. 1;

FIG. 5 is a schematic view showing the structure along D-D direction in FIG. 1.

### DETAILED DESCRIPTION OF THE INVENTION

The present invention will now be described in detail with reference to the above drawings. For the convenience of description, the orientations described below are now defined as follows: the front-back and left-right directions described below coincide with the vertical direction of the projection relationship of FIG.

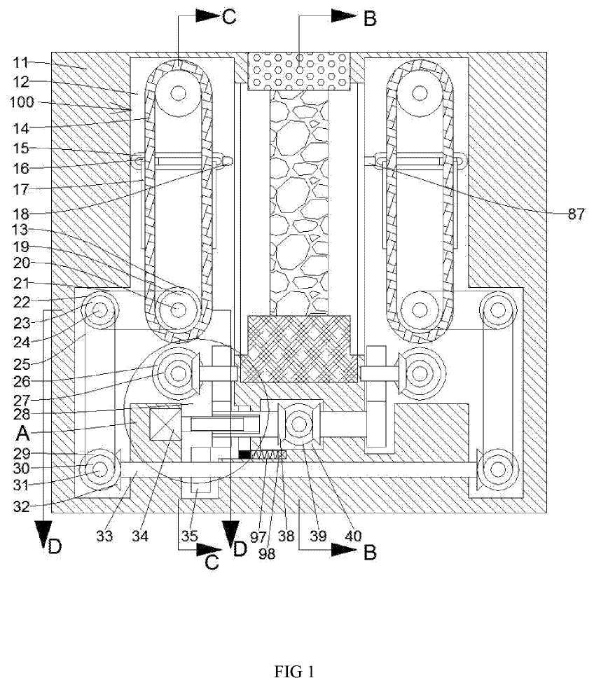

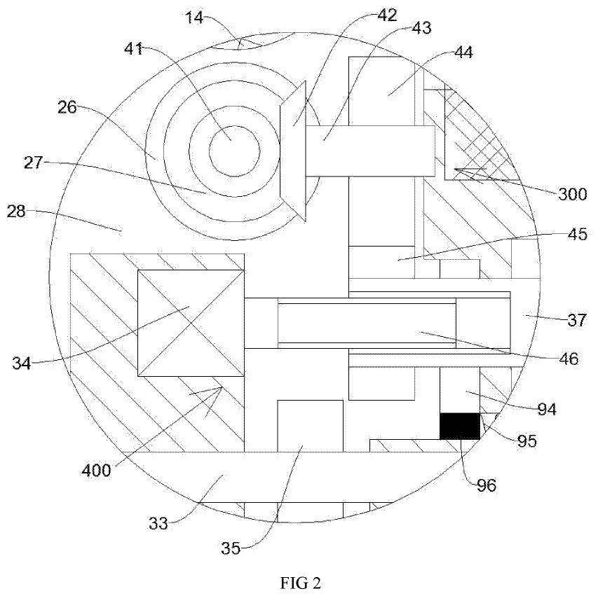

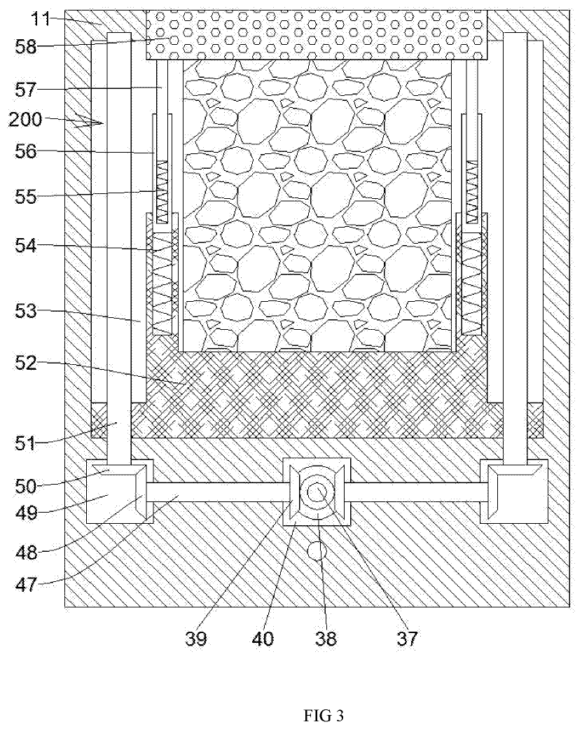

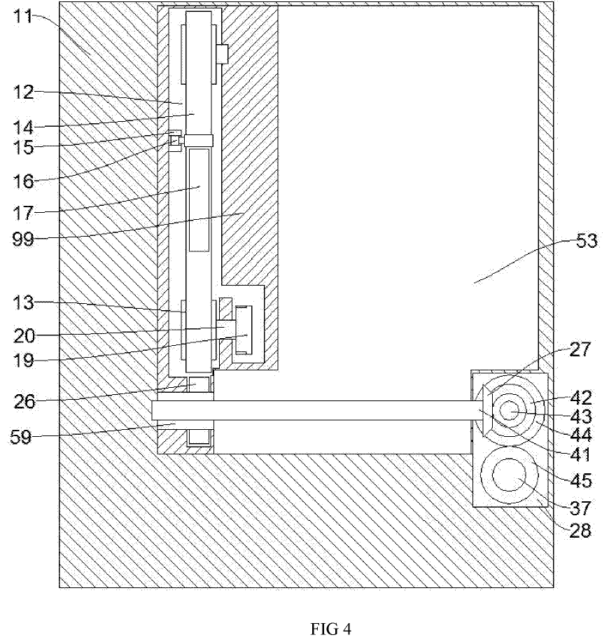

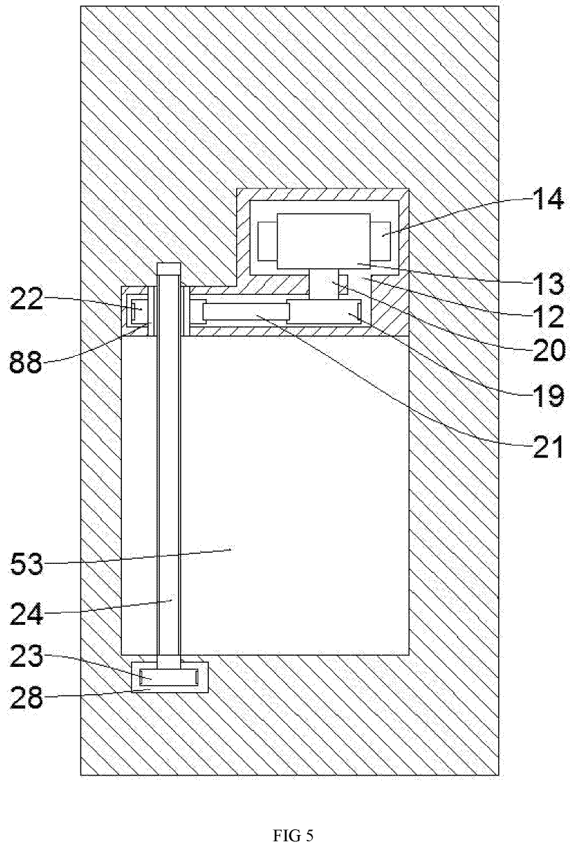

As shown in FIG. 1-5, a crystal purity detecting device of the present invention includes a body 11, a detecting chamber 53 is disposed in the body 11, and a detecting device 100 is disposed in the detecting chamber 53, and the detecting chamber is provided. A symmetrical power chamber 28 is disposed in the inner wall of the left and right sides of the 53. The detecting chamber 53 is provided with a lifting device 200. The power chamber 28 is provided with a transmission device 300. The power chamber 28 is provided with a power device 400. The power unit 400 includes a motor 34 disposed in a left wall of the power chamber 28, and a power shaft 46 electrically coupled to the motor 34 is disposed in the power chamber 28; the power unit 400 can pass the transmission The device 300 drives the detecting device 100 to rotate, and the crystal to be detected is subjected to a purity detecting operation.

Advantageously, the detecting device 100 includes a detecting body 99 which is symmetrically disposed in the detecting chamber 53. The detecting body 99 on the left side is taken as an example for detailed description. The detecting body 99 is provided with a sliding cavity. The sprocket 13 is disposed on the outer wall of the support shaft 20, and the chain sprocket 13 is disposed between the sprocket 13 on the upper and lower sides. A sliding frame 15 is slidably disposed in the cavity 12, and a slider 16 is slidably disposed in the sliding frame 15, and the slider 16 is rotatably disposed on the chain 14, and the sliding frame on the left side The right end of the 15 is provided with an illuminator 18, and the left end of the carriage 15 is provided with a photoreceptor 87 for receiving the light beam emitted by the illuminator 18, and the front end of the support shaft 20 of the lower side is provided with a pulley 19, a sleeve shaft 88 is disposed in the sliding chamber 12, and a main pulley 22 is disposed on an outer wall of the sleeve shaft 88. A first belt 21 is disposed between the main pulley 22 and the slave pulley 19, A mandrel 24 is disposed in the detecting chamber 53. The mandrel 24 is spline-fitted with the sleeve shaft 88. The front end of the mandrel 24 is provided with an upper pulley 23, and the chain 14 is left and right. The shank is provided with a threaded sleeve 59. The sliding sleeve 12 is provided with a threaded sleeve 59. The outer wall of the threaded sleeve 59 is provided with a running gear 26. The detecting chamber 53 is provided with a traveling screw 41. The traveling screw 41 is provided. The threaded sleeve 59 is threadedly engaged, and the front end of the traveling screw 41 is provided with a bevel gear 27; the detecting device 100 is used for detecting crystal purity.

Advantageously, the lifting device 200 includes a base 52 that is slidably disposed in the detecting cavity 53. The base 52 is slidably provided with a left-right symmetric middle pole 56, and the middle pole 56 and the base The first spring 54 is elastically disposed between the 52, the upper rod 57 is slidably disposed therein, and the second rod 55 is elastically disposed between the upper rod 57 and the middle rod 56. A top cover 58 is connected to the top end of the rod 57. The bottom end wall of the detecting chamber 53 is symmetrically disposed with a switching chamber 49. An extension chamber 40 is disposed between the two power chambers 28, and the detecting chamber 53 is disposed. The front and rear symmetrical lifting screws 51 are provided, and the lifting screw 51 is screwed to the base 52. The bottom end of the lifting screw 51 is provided with a bevel gear 50, and the conversion cavity 49 is provided with an extending shaft 47. A rear bevel gear 48 is disposed at one end of the extension shaft 47 away from the extension cavity 40. The extension shaft 47 is provided with a front bevel gear 39 near one end of the extension cavity 40. The lifting device 200 can facilitate the placement of the crystal to be tested.

Advantageously, the transmission device 300 includes a main shaft 37 symmetrically disposed in the power chamber 28, which is described in detail by taking the left side as an example. The main shaft 37 on the left side and the power shaft 46 are spline-fitted. a main gear 45 is disposed at a left end of the main shaft 37, a right bevel gear 38 is disposed at a right end of the main shaft 37, and a sliding groove 97 is disposed in a right wall of the main shaft 37. The sliding groove 97 is slidably provided with a permanent a magnet 96, the outer wall of the main shaft 37 is rotatably provided with a rotating block 94 fixed to the permanent magnet 96, and an electromagnet 98 is disposed in the right wall of the sliding groove 97, and the permanent magnet 96 and the electromagnetic A third spring 95 is disposed between the irons 98. The power chamber 28 is provided with a recovery shaft 43. The right end of the recovery shaft 43 is provided with a one-way gear 44, and the left end of the recovery shaft 43 is provided with a main bevel gear 42. The power chamber 28 is provided with a transmission shaft 33. The outer wall of the transmission shaft 33 is provided with a slave gear 35. The right and left ends of the transmission shaft 33 are symmetrically disposed with a right bevel gear 32, and the power chamber 28 is provided with a lower portion. a shaft 31, a rear end of the lower shaft 31 is provided with a left bevel gear 29, a front end of the lower shaft 31 is provided with a lower pulley 30, and the lower pulley 30 and the upper pulley 2 The transmission between the three belts is provided with a second belt 25; the transmission device 300 can transmit power into each of the above devices.

When the apparatus is used, the motor 34 operates in reverse and drives the main shaft 37 to rotate through the power shaft 46, and further passes through the bevel gear 38, the front bevel gear 39, the extension shaft 47, the rear bevel gear 48, the bevel gear 50, and the lifting screw 51. The base 52 and the top cover 58 are driven to slide upward, and the user puts the crystal to be tested, and the motor 34 works in the forward direction, and then the base 52 and the top cover 58 are slid downward through the lifting screw 51 to enter the inside of the device, and at the same time, the main shaft 37 The main body gear 45, the one-way gear 44, the recovery shaft 43, the main bevel gear 42, the bevel gear 27, the traveling screw 41, and the threaded sleeve 59 drive the detecting body 99 to slide backward. When the crystal completely enters the apparatus, the electromagnet 98 The main gear 45 is driven to the left by the permanent magnet 96, the rotating block 94, and the main shaft 37, and the main shaft 37 passes through the main gear 45, the driven gear 35, the transmission shaft 33, the right bevel gear 32, the left bevel gear 29, and the lower shaft 31. The lower pulley 30, the upper pulley 23, the spindle 24, the sleeve shaft 88, the main pulley 22, the pulley 19, the support shaft 20, and the sprocket 13 drive the chain 14 to rotate, and then pass through the slider 16, the carriage 15 The illuminator 18 (photoreceptor 87) is driven to slide up and down, and the illuminator 18 is emitted. The emitted light beam is received by the photoreceptor 87 after passing through the crystal. At this time, the purity of the crystal can be determined by determining the intensity of the light beam received by the photoreceptor 87.

When the illuminator 18 is slid to the uppermost (lower), the rack is rotated. 17 meshes with the travel gear 26, and the rack 17 drives the threaded sleeve 59 to rotate by the travel gear 26, thereby driving the detecting body 99 to slide forward. When the detecting body 99 slides to the foremost side, the crystal detection is completed, and the electromagnet 98 is powered off. The main shaft 37 slides to the right, the bevel gear 38 meshes with the front bevel gear 39, and the motor 34 operates in the reverse direction, and the base 52 and the top cover 58 are slid upward by the lifting screw 51, and the user takes out the crystal.

The invention has the advantages that the structure is simple, the operation is convenient, and the maintenance is convenient. The device can detect various positions of the crystal, the accuracy of the device judgment is high, and the labor intensity of the professional is lowered, so the device has high use and promotion value.

The above is only the specific embodiment of the invention, but the scope of the invention is not limited thereto, and any changes or substitutions that are not thought of by the creative work are included in the scope of the invention. Therefore, the scope of protection of the invention should be determined by the scope of protection defined by the claims.

1. A crystal purity detecting apparatus according to the present invention, comprising a body, wherein the detecting body is provided with a detecting chamber, and the detecting chamber is provided with detecting means, wherein the inner wall of the left and right sides of the detecting chamber is provided with a symmetrical dynamic cavity a lifting device is disposed in the detecting chamber, a transmission device is disposed in the power chamber, a power device is disposed in the power chamber, and the power device includes a motor disposed in a left wall of the power chamber, The power chamber is provided with a power shaft connected to the motor; the power device can drive the detecting device to rotate by the transmission device, and the purity detecting operation is performed on the crystal to be detected.

2. The crystal purity detecting apparatus according to claim 1, wherein the detecting device comprises a detecting body disposed symmetrically in the detecting chamber, wherein the detecting body on the left side is taken as an example. In detail, the detecting body is provided with a sliding cavity, wherein the sliding cavity is vertically symmetrically provided with a supporting shaft, the outer wall of the supporting shaft is provided with a sprocket, and the chain is driven between the sprocket on the upper and lower sides. a slider is slidably disposed in the sliding cavity, and a slider is slidably disposed in the sliding frame, the slider is rotatably disposed on the chain, and the right end of the sliding frame is disposed on the left side There is an illuminator, a left end of the sliding frame on the right side is provided with a photoreceptor for receiving a light beam emitted by the illuminator, and a front end of the support shaft of the lower side is provided with a slave pulley, and a sleeve shaft is arranged in the sliding cavity a main pulley is disposed on the outer wall of the sleeve shaft, and a first belt is disposed between the main pulley and the slave pulley, and a core shaft is disposed in the detection cavity, and the core shaft is The sleeve shaft is matched by a spline, and the front end of the mandrel is provided with an upper pulley, and the chain is bilaterally symmetrical a rack is disposed, a threaded sleeve is disposed in the sliding cavity, a traveling gear is disposed on the outer wall of the threaded sleeve, a walking screw is disposed in the detecting cavity, and the running screw and the threaded sleeve are threadedly matched The front end of the walking screw is provided with a bevel gear; the detecting device is used for detecting the purity of the crystal.

3. The crystal purity detecting apparatus according to claim 2, wherein said lifting device comprises a base slidably disposed in said detecting chamber, said base being slidably provided with left and right symmetry a middle rod, a first spring is elastically disposed between the middle rod and the base, a middle rod is slidably disposed in the middle rod, and a second spring is elastically disposed between the upper rod and the middle rod a top cover is connected to the top end of the upper rod, and a conversion chamber is disposed in the bottom end wall of the detection chamber, and an extension chamber is disposed between the power chambers on the two sides, and the detection chamber is provided with front and rear a symmetrical lifting screw, the lifting screw is screwed to the base, a bottom bevel gear is arranged at a bottom end of the lifting screw, an extension shaft is disposed in the conversion cavity, and the extension shaft is disposed away from the extension cavity There is a bevel gear, and the extension shaft is provided with a front bevel gear near one end of the extension cavity; the lifting device can facilitate the placement of the crystal to be tested.

4. The crystal purity detecting apparatus according to claim 3, wherein said transmission means comprises a main shaft symmetrically disposed in said power chamber, wherein the left side is taken as an example for detailed description, and the left side is The main shaft and the power shaft are spline-fitted, the left end of the main shaft is provided with a main gear, the right end of the main shaft is provided with a forward bevel gear, and the right wall of the power chamber is provided with a sliding slot, and the sliding slot can be provided therein. a sliding permanent magnet is disposed on the outer wall of the main shaft, and a rotating block fixed to the permanent magnet is disposed on the outer wall of the main shaft, and an electromagnet is disposed in the right wall of the sliding slot, and the permanent magnet and the electromagnet are The third spring is disposed between the elastic chamber, the recovery shaft is provided with a recovery shaft, the right end of the recovery shaft is provided with a one-way gear, the left end of the recovery shaft is provided with a main bevel gear, and the power chamber is provided with a transmission shaft. The outer wall of the transmission shaft is provided with a slave gear, and the left and right ends of the transmission shaft are symmetrically disposed with a right bevel gear, a lower shaft is disposed in the power chamber, and a left bevel gear is disposed at a rear end of the lower shaft, the lower portion The front end of the shaft is provided with a lower pulley, and the lower pulley and the upper pulley are driven A second belt is provided; the transmission transmits power to each of the above devices.
